(19) United States
(12) Patent Application Publication
(10) Pub. No.: US 2010/0147926 A1
(43) Pub. Date: Jun. 17, 2010

(54) METHOD FOR OXIDE BONDING USING SOLDER ALLOY

(75) Inventors: MINORU YAMADA, TOKYO (JP); NOBUHIKO CHIWATA, TOKYO (JP)

Correspondence Address: J C PATENTS, 4 VENTURE, SUITE 250, IRVINE, CA, 92618, US

(73) Assignees: SOPHIA PRODUCT CO., TOKYO (JP); HITACHI METALS, LTD., TOKYO (JP)

(21) Appl. No.: 12/712,984

(22) Filed: Feb. 25, 2010

Related U.S. Application Data
(63) Continuation of application No. 11/994,324, filed on Dec. 28, 2007.

(30) Foreign Application Priority Data
Jul. 14, 2005 (JP) 2005-233746

(51) Int. Cl. B23K 31/02

(52) U.S. Cl. 228/121

(57) ABSTRACT

A lead-free metal solder material capable of realizing excellent bonding strength and hermetic sealing is provided. The solder alloy is a solder alloy for bonding to an oxide, and includes 2.0-15.0 mass % of Ag, more than 0.1-6.0 mass % of Al, and the remainder is composed of Sn and some inevitable impurities. The content of Al is preferably 0.3-3.0 mass %, and more preferably 0.5-3.0 mass %. The content of Ag is preferably 3.0-13.0 mass %, more preferably more than 5.0-12.0 mass %, and most preferably 6.0-10.0 mass %. A relation between Ag and Al that fits the inequality 0<[(% Ag)−(% Al)×7.8]<10 is desirable. The solder alloy for bonding to an oxide of the present invention is used for bonding between glasses, for instance, and has excellent effects.

### BACKGROUND OF THE INVENTION

1. Field of the Invention

The present invention relates to an optimal solder alloy for bonding to oxide materials such as glass and ceramic. More particularly, the present invention relates to a technical field of welding (sealing) with a lead-free alloy solder to fabricate dual-layer glass, vacuum containers, or sealed glass containers.

2. Description of Related Art

In the conventional bonding techniques for bonding glass and etc., a method of bonding and welding performed at about 380° C. mainly uses a lead-containing solder or a lead glass material. However, lead cannot be used any more due to environmental problems. In the other aspect, in various wax materials and brazing sheets disclosed in “JIS Handbook (3) Non-ferrous metals”, it is difficult to supply a material that melts below 400° C. and has good adhesion, and is capable to bond without the problems of contraction and cracking of a glass resulted from the difference between the thermal expansion coefficients of the glass and the wax materials.

Accordingly, sealing materials with In (indium) and an In alloy as a metal material have been set forth recently (please see Japanese Patent Early Laid-open Publications No. 2002-020143 and No. 2002-542138). Furthermore, an In-based solder alloy is further set forth, which is formed by adding various elements, such as Al, Ag, Cu, and Zn, into a material with Sn as the principal composition, in addition to a large amount of In (please see Japanese Patent Early Laid-open Publication No. 2000-141078).

As lead free metal solder materials having a low melting point, the materials disclosed in Japanese Patent Early Laid-open Publications No. 2002-020143, No. 2002-542138, and No. 2000-141078 have excellent bonding strength and hermetic sealing capability on oxide materials, such as glass and ceramic. However, the supply of In that must be added during the application is inadequate; thus, the application of methods in Japanese Patent Early Laid-open Publications No. 2002-020143 and No. 2002-542138 is limited due to high cost. Furthermore, even for the method in Japanese Patent Early Laid-open Publication No. 2000-141078, in which effects are obtained by adding a small amount of In, a great deal of time is demanded for adjusting the compositions as various elements are required to be added besides In (indium).

### SUMMARY OF THE INVENTION

Accordingly, the present invention is directed to provide a lead-free metal solder material, which is a solder alloy merely for bonding to an oxide and capable of realizing excellent bonding strength and hermetic sealing by a composition system as simple as possible, so as to solve the above problems.

It has been identified that, a ternary Sn-based lead-free solder alloy having the composition balance below can directly bond oxide materials, which are represented by glass, with high bonding strength.

Accordingly, the present invention provides a solder alloy for bonding to an oxide, which contains 2.0-15.0 mass % of Ag, more than 0.1-6.0 mass % of Al, and the remainder is composed of Sn and some inevitable impurities. The content of Al is preferably 0.3-3.0 mass %, and more preferably 0.5-3.0 mass %. The content of Ag is preferably 3.0-13.0 mass %, and more preferably more than 5.0-12.0 mass %, and most preferably 6.0-10.0 mass %. Furthermore, a relation between Ag and Al that fits the following equation: 0<[(% Ag)−(% Al)×7.8]<10 is preferred. The solder alloy for oxide bonding of the present invention is used for bonding glass, for instance, and has an excellent effect.

In accordance to the present invention, a lead-free and environmental-friendly solder alloy for bonding to an oxide is provided, in which the solder alloy of the invention has a simple composition design and requires no complex production process. Further, the solder alloy of the invention has excellent bonding strength and hermetic sealing capability. Furthermore, the operating temperature of the solder alloy for bonding to an oxide of the present invention can be selected from a low heating range of about 230° C.-400° C., for example, for the welding of a dual-layer glass and a glass container, to conserve thermal energy.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an electron microscope picture showing a cross-section of a bonding between soda glass substrates by using a solder alloy according to an embodiment of the present invention.

FIG. 2 is an electron microscope picture showing a cross-section of a bonding between a soda glass and Fe-42% Ni alloy by using a solder alloy according to an embodiment of the present invention.

FIG. 3 is an electron microscope picture showing a cross-section of a bonding between aluminum oxide and copper by using a solder alloy according to an embodiment of the present invention.

FIG. 4 is a schematic diagram showing a three point bending test for evaluating the bonding strength according to an embodiment of the present invention.

FIG. 5 is a schematic diagram showing a leakage test for evaluating the vacuum sealing properties of a bonding surface according to an embodiment of the present invention.

### DESCRIPTION OF EMBODIMENTS

Hereinafter, the reasons of limiting the composition of the solder alloy of the present invention are illustrated. The compositions of the solder alloy is presented in “%”, which represents mass percentage (mass %).

Al(aluminum):more than 0.1% to 6.0%

For a Sn—Ag-based solder alloy of the present invention, Al is an indispensable and necessary metal for bonding with an oxide material. That is, in the Sn—Ag-based solder alloy, if varying the contents of Sn and Ag still results with difficulties in bonding with the oxide material, the wettability to the oxide material can be increased by adding Al, so as to enhance the adhesion with the oxide material. The reason is that, Al has a strong tendency to form an oxide material, so Al can easily combine with the oxide, and to increase the wettability to the oxide material. However, if an excessive amount of Al is added, an aluminum oxide material is formed, which will reduce the bonding or increase the metal solidification shrinkage, and the problem of fracturing of the bonded articles (oxide). Therefore, the content of Al, with respect to the content of Ag described below, is more than 0.1% to 6.0%, preferably between 0.5% to 3.0%, and more preferably 0.5% to 1.5%.

Ag:2.0% to 15.0%

For a Sn—Ag—Al ternary solder alloy of the present invention, Ag is the most suitably used to control the amount of Al in Sn. For the lead-free metal alloy solder with Al added in Sn of the present invention, Ag is an indispensable and necessary metal. Furthermore, as Ag is an element that inhibits the formation of an oxide layer of the metal solder, Ag is further an important and necessary element. However, if an excessive amount of Ag is added, a large amount of hard and brittle intermetallic compound is formed in the solder; thus, the bonding strength is reduced. In the other aspect, if insufficient Ag is added, as the principal composition Sn is a soft metal, the hardness of the solder itself due to the formation of the intermetallic compounds becomes indefinite; thus, the desired bonding strength cannot be obtained. Furthermore, as the solid-solution of Al in Sn cannot be ensured, the wettability to the oxide material serving as the bonded article is reduced. Therefore, the content of Ag, with respect to the added amount of Al described above, is more than 2.0% to 15.0%, preferably 3.0% to 13.0%, more preferably 5.0% to 12.0%, and most preferably 6.0% to 10.0%.

0<[(%Ag)−(%Al)×7.8]<10

For the Sn—Ag—Al-based solder alloy of the present invention, the relation between Al and Ag is important and it is preferably to adjust Al and Ag correspondingly. That is, when the dispensation ratio of Al and Ag is optimally controlled according to the present invention so as to optimize the adhesion with the oxide material, and under the condition of controlling the formation of the intermetallic compound of Al and Ag, if excessive Al is added relative to the content of Ag, Al will be segregated, the wettability to the oxide material is reduced. Furthermore, if the amount of Al is small relative to the content of Ag, sufficient wettability might not be obtained as Al, that is capable of increasing the wettability, is entangled with Ag during forming the intermetallic compound. Therefore, during the process of further increasing the wettability, the optimal adjusting index of Ag and Al has been identified that the calculated value of [(% Ag)−(% Al)×7.8] is preferred as a standard. Furthermore, the calculated value preferably satisfies the inequality of 0<[(% Ag)−(% Al)×7.8]<10, which is effective for increasing the wettability when vacuum sealing is performed by oxide bonding.

Remainder(Sn and inevitable impurities)

Sn is an essential element of the solder alloy of the present invention, which can alleviate the thermal expansion coefficient to the oxide material and reduce the melting temperature. Particularly, during the adjustment of the thermal expansion coefficient, the content of Sn is preferably adjusted to the range of 85% to 90%.

The solder alloy of the present invention can achieve excellent bonding strength and hermetic sealing by limiting the bonding article as being an oxide material. That is, the solder alloy of the present invention can definitely exert excellent bonding capability on ceramics such as aluminum oxide and glass such as soda lime glass, and to the materials that are not the above oxides. Furthermore, the present invention is not merely used for the bonding between the above oxide materials. As long as at least one article is an oxide material, the other article can be a material that is not an oxide material and a bonding capability can be ensured. For example, the solder alloy of the present invention even has bonding capability on various metals, such as stainless steel, copper, Fe—Ni-based alloy. Even the other article is a material of poor bonding capability, if a surface treatment is applied thereon to provide the bonding capability, the material can also be used without limitation.

Furthermore, as for the application of the solder alloy of the present invention, the supply of the bonding material is preferably performed under a pre-melted condition. That is, when the solder alloy is in a solid state, most of its surface is likely to be oxidized. The oxide layer formed on the surface is the main reason in hindering the solder bonding. However, if the solder alloy is in a pre-melted state, the surface can keep fresh with merely a little oxidation. Therefore, if the bonding material is attached onto the solder alloy after the solder alloy is melted, good bonding strength can be obtained. As an embodiment, for example, the bonding material can be used in the following configurations, i.e., the melted solder alloy can be infused between bonding surfaces of the bonding material units in final configuration after combination; alternatively, another bonding material is disposed on the melted solder alloy disposed on a surface of the bonding material.

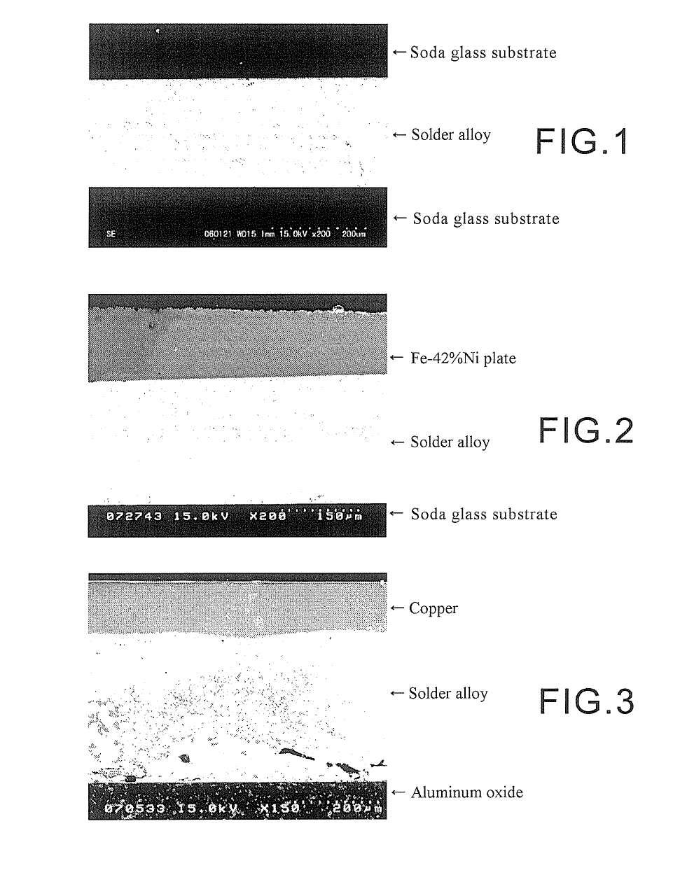

FIG. 1 is an enlarged, cross-sectional view of a bonding of soda glass substrates by using a Sn-7% Ag-0.5% Al solder alloy of the present invention. Similarly, FIG. 2 is an enlarged cross-section view of a bonding between a soda glass substrate and a Fe-42% Ni alloy by using the same solder alloy of the present invention. Furthermore, FIG. 3 is an enlarged, cross-sectional view of a bonding between an aluminum oxide and copper by using the same solder alloy of the present invention.

The requisite compositions Sn, Ag, and Al are weighted and melted at high frequency under an Ar (argon) atmosphere. The compositions are then infused into a mold under the same environment, so as to fabricate a solder alloy. Thereafter, the resulting solder alloy is evaluated according to the test methods below. Furthermore, in the evaluation, in order to be welded easily, the solder alloy is cut and processed into small pieces for use.

### Embodiment 1

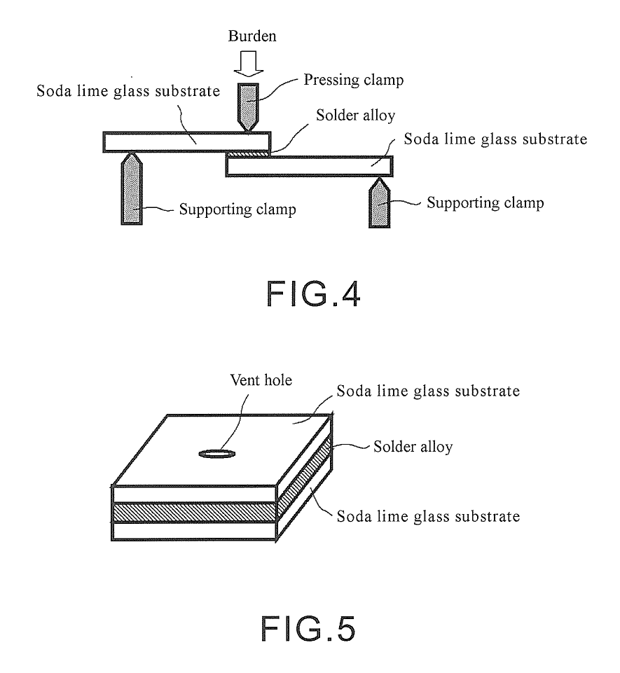

In order to measure the bonding strength, test sheets are prepared, two glass plates are connected by the solder alloy, and a three point bending test is performed thereon. The test sheets are two soda lime glass substrates, which are 3 mm thickness ×50 mm length×25 mm width and bonded by a bonding material of 6 mm length at different positions (FIG. 4). Then, the bonded test sheets are used to perform the three point bending test, in which the bonding sites are striped, and the load is determined when the two glass plates are separated or the test sheets are damaged. The load evaluation test machine is MODEL-1308 manufactured by AIKON ENGINEERING CO., LTD. The test results and the compositions of the used solder alloy are listed in Table 1 together.

TABLE 1

| | | | | | Three Point | |
|---|---|---|---|---|---|---|
| | | | | | Bending | |
| | Composition [mass %] | | | | Test Damage | |
| Sample | | | | (% Ag) − | Burden | |
| No. | Sn | Ag | Al | 7.8(% Al) | (N/mm) | Remarks |
| 1 | Bal. | 2.0 | 0.5 | −1.9 | 1.99 | Embodiments |
| 2 | Bal. | 2.0 | 1.5 | −9.7 | 1.01 | |
| 3 | Bal. | 2.0 | 4.0 | −29.2 | 0.90 | |
| 4 | Bal. | 3.5 | 0.5 | −0.4 | 1.21 | |
| 5 | Bal. | 3.5 | 1.5 | −8.2 | 1.00 | |
| 6 | Bal. | 3.5 | 4.0 | −27.7 | 1.03 | |
| 7 | Bal. | 5.0 | 0.5 | 1.1 | 1.36 | |
| 8 | Bal. | 5.0 | 1.5 | −6.7 | 1.18 | |
| 9 | Bal. | 5.0 | 4.0 | −26.2 | 1.18 | |
| 10 | Bal. | 7.0 | 0.1 | 6.2 | 1.23 | |
| 11 | Bal. | 7.0 | 0.2 | 5.4 | 1.44 | |
| 12 | Bal. | 7.0 | 0.3 | 4.7 | 1.53 | |
| 13 | Bal. | 7.5 | 0.5 | 3.6 | 1.61 | |
| 14 | Bal. | 7.5 | 1.5 | −4.2 | 1.31 | |
| 15 | Bal. | 7.5 | 4.0 | −23.7 | 1.21 | |
| 16 | Bal. | 12.0 | 0.5 | 8.1 | 1.31 | |
| 17 | Bal. | 12.0 | 1.5 | 0.3 | 1.97 | |
| 18 | Bal. | 12.0 | 4.0 | −19.2 | 1.25 | |
| 19 | Bal. | 15.0 | 0.5 | 11.1 | 0.91 | |
| 20 | Bal. | 15.0 | 4.0 | −16.2 | 0.88 | |
| 21 | Bal. | 3.5 | — | 3.5 | Incapable of | Comparative |
| | | | | | bonding | example |

It can be known from Table 1 that, a sufficient bonding strength greater than or equal to 0.8 N/mm can be obtained by using test sheets of Sample No. 1-20 solder alloy meeting the requirements of the present invention. Furthermore, the bonding strength becomes higher as the composition approaches to the preferred composition of the present invention, particularly as Ag approaches the preferred composition. For the test sheets of Samples No. 1 and No. 17, the solder alloy has excellent bonding strength when the glass is damaged. Furthermore, the Al-free solder alloy of Sample No. 21, which is outside of the present invention, cannot be applied on the glass and cannot be bonded itself.

The solder alloy of the present invention is required to be a solder alloy “for an oxide bonding”; thus, a sufficient bonding strength must be ensured first. Furthermore, by adjusting a desirable composition of the solder alloy stress relaxation and hermetic sealing of the solder bonding site are provided. Accordingly, the solder alloy of the invention can be applied in many fields. Hereinafter, the properties are evaluated.

### Embodiment 2

A soda lime glass substrate of 5 mm thickness×40 mm length×40 mm is placed on a heating plate and heated to about 380° C. Then, under the ambient atmospheric condition, the solder alloy is coated on a surface of the soda lime glass substrate to about 0.4 mm thick. The internal stress of the glass is determined by polarization compensation method (Senarmont method). The determination is directed to determining the internal stress on the bonding surface of the solder alloy and the internal stress on the surface without being coated with the solder alloy, and obtaining the difference of the stresses as the increment of the internal stress of the glass due to the coating of the solder alloy when the compressive stress is positive. The test results and the compositions of the used solder alloy are listed in Table 2 together.

TABLE 2

| | | | | | Internal | | |
|---|---|---|---|---|---|---|---|
| Sample | Composition [mass %] | | | | Stress | Visual | |
| No. | Sn | Ag | Al | (% Ag) − 7.8(% Al) | (kN/cm²) | Inspection | Remarks |
| 1 | Bal. | 2.0 | 0.5 | −1.9 | (0.79) | Glass | Embodiments |
| | | | | | | fractured | of the |
| 2 | Bal. | 2.0 | 1.5 | −9.7 | (0.86) | Glass | present |
| | | | | | | fractured | invention |
| 3 | Bal. | 2.0 | 4.0 | −29.2 | (0.79) | Glass | |
| | | | | | | fractured | |
| 4 | Bal. | 3.5 | 0.5 | −0.4 | 1.79 | | |
| 5 | Bal. | 3.5 | 1.5 | −8.2 | 1.84 | | |
| 6 | Bal. | 3.5 | 4.0 | −27.7 | (0.26) | Peeled Off | |
| 7 | Bal. | 5.0 | 0.5 | 1.1 | 1.81 | | |
| 8 | Bal. | 5.0 | 1.5 | −6.7 | (1.81) | Glass | |
| | | | | | | fractured | |
| 9 | Bal. | 5.0 | 4.0 | −26.2 | (0.26) | Peeled Off | |
| 10 | Bal. | 7.0 | 0.1 | 6.2 | 0.37 | | |
| 11 | Bal. | 7.0 | 0.2 | 5.4 | 0.65 | | |
| 12 | Bal. | 7.0 | 0.3 | 4.7 | 0.71 | | |
| 13 | Bal. | 7.5 | 0.5 | 3.6 | 0.70 | | |
| 14 | Bal. | 7.5 | 1.5 | −4.2 | 0.28 | | |
| 15 | Bal. | 7.5 | 4.0 | −23.7 | 0.15 | | |
| 16 | Bal. | 12.0 | 0.5 | 8.1 | 0.72 | | |
| 17 | Bal. | 12.0 | 1.5 | 0.3 | 0.74 | | |
| 18 | Bal. | 12.0 | 4.0 | −19.2 | 0.64 | | |
| 19 | Bal. | 15.0 | 0.5 | 11.1 | 0.38 | | |
| 20 | Bal. | 15.0 | 4.0 | −16.2 | (0.41) | Glass | |
| | | | | | | cleaved | |
| 21 | Bal. | 3.5 | — | 3.5 | — | Incapable | Comparative |
| | | | | | | of bonding | Example |

It can be known from Table 2 that, in the samples meeting the requirements of the present invention, especially for the samples in which the content of Al is in the desired range of smaller than or equal to 3.0%, the solidification shrinkage of the solder alloy can be inhibited, and the residual stress inside the glass is reduced, thereby preventing the glass from being fractured and peeled off. Furthermore, as for the samples in which the glass is fractured and peeled off, the determined values of the internal stress are low values and are represented in the parentheses in the table as reference values, since the stress has been relaxed due to the fracturing and peeling of the glass.

### Embodiment 3

A soda lime glass substrate of 3 mm thickness×50 mm length×50 mm is heated to 380° C. on a glass, and a solder alloy of about 2 mm width is coated around a surface of the glass substrate. Then, a substrate of the same size, pre-heated to the same temperature and having a 3 mm Φ hole at central portion, is laminated on the surface, and the two pieces of glass are bonded. At this time, as a stainless steel foil of about 0.1 mm thickness (about 1 mm angle) is disposed between the glass surfaces as a pad, a container having 0.1 mm height space inside is formed (FIG. 5). And then, for the obtained container, the space is vacuumed by a leakage detector (HELLOT700, manufactured by ULVAC) and a helium (He) gas is blown to each bonding site to determine leakage. The test results and the compositions of the used solder alloy are listed in Table 3 together.

TABLE 3

| | Composition [mass %] | | | | | |
|---|---|---|---|---|---|---|
| Sample | | | | (% Ag) − | Leakage | |
| No. | Sn | Ag | Al | 7.8(% Al) | (*10⁻⁹[Pa · m³/s]) | Remarks |
| 1 | Bal. | 2.0 | 0.5 | −1.9 | Undetectable | Embodi- |
| 2 | Bal. | 2.0 | 1.5 | −9.7 | Undetectable | ments of the |
| 3 | Bal. | 2.0 | 4.0 | −29.2 | Undetectable | present |
| 4 | Bal. | 3.5 | 0.5 | −0.4 | Undetectable | invention |
| 5 | Bal. | 3.5 | 1.5 | −8.2 | Undetectable | |
| 6 | Bal. | 3.5 | 4.0 | −27.7 | Undetectable | |
| 7 | Bal. | 5.0 | 0.5 | 1.1 | 4.5 | |
| 8 | Bal. | 5.0 | 1.5 | −6.7 | 44 | |
| 9 | Bal. | 5.0 | 4.0 | −26.2 | 240 | |
| 10 | Bal. | 7.0 | 0.1 | 6.2 | 0.002 | |
| 11 | Bal. | 7.0 | 0.2 | 5.4 | 0.001 | |
| 12 | Bal. | 7.0 | 0.3 | 4.7 | 0.0073 | |
| 13 | Bal. | 7.5 | 0.5 | 3.6 | 0.63 | |
| 14 | Bal. | 7.5 | 1.5 | −4.2 | 32 | |
| 15 | Bal. | 7.5 | 4.0 | −23.7 | 150 | |
| 16 | Bal. | 12.0 | 0.5 | 8.1 | 4.3 | |
| 17 | Bal. | 12.0 | 1.5 | 0.3 | 5.7 | |
| 18 | Bal. | 12.0 | 4.0 | −19.2 | 150 | |
| 19 | Bal. | 15.0 | 0.5 | 11.1 | 840 | |
| 20 | Bal. | 15.0 | 4.0 | −16.2 | 21000 | |
| 21 | Bal. | 3.5 | — | 3.5 | Incapable of | Comparative |
| | | | | | bonding | example |

It can be known from Table 3 that, in the samples meeting the requirements of the present invention, especially for the samples in which the content of Ag is in the desired range of about 7%, preferred results of no fracture of the bonding surface and less leakage are obtained. Further, for the samples in which the content of Al is also in the desired range of less than or equal to 1.5%, less leakage occurs. Furthermore, with respect to the index value of [(% Ag)−(% Al)×7.8] being introduced in the present invention, a sample with an index value of about 5, the sample shows the lowest tendency in leakage. Furthermore, for Samples No. 1-6, the leakage test cannot be performed due to the fracture on the bonding surface.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for oxide bonding using solder alloy, comprising:
providing a first oxide and a second oxide; and
providing a solder alloy between the first oxide and the second oxide to bond the first oxide and the second oxide, wherein the solder alloy consists of 2.0 mass % to 15.0 mass % of Ag (silver), more than 0.1 mass % to 3.0 mass % of Al (aluminum), and the balance Sn (tin) and inevitable impurities.

2. The method as claimed in claim 1, wherein the content of Al is 0.3 mass % to 3.0 mass %.

3. The method as claimed in claim 1, wherein the content of Al is 0.5 mass % to 3.0 mass %.

4. The method as claimed in claim 1, wherein the content of Ag is 3.0 mass % to 13.0 mass %.

5. The method as claimed in claim 1, wherein the content of Ag is more than 5.0 mass % to 12.0 mass %.

6. The method as claimed in claim 1, wherein the content of Ag is 6.0 mass % to 10.0 mass %.

7. The method as claimed in claim 1, wherein a relation between Ag and Al in a mass % satisfies an inequality of 0<[(% Ag)−(% Al)×7.8]<10.

8. The method as claimed in claim 2, wherein a relation between Ag and Al in a mass % satisfies an inequality of 0<[(% Ag)−(% Al)×7.8]<10.

9. The method as claimed in claim 3, wherein a relation between Ag and Al in a mass % satisfies an inequality of 0<[(% Ag)−(% Al)×7.8]<10.

10. The method as claimed in claim 4, wherein a relation between Ag and Al in a mass % satisfies an inequality of 0<[(% Ag)−(% Al)×7.8]<10.

11. The method as claimed in claim 5, wherein a relation between Ag and Al in a mass % satisfies an inequality of 0<[(% Ag)−(% Al)×7.8]<10.

12. The method as claimed in claim 6, wherein a relation between Ag and Al in a mass % satisfies an inequality of 0<[(% Ag)−(% Al)×7.8]<10.

13. The method as claimed in claim 1, wherein the first oxide and the second oxide are independently glass or aluminum oxide.
